(19) United States
(12) Patent Application Publication
(10) Pub. No.: US 2019/0258575 A1
(43) Pub. Date: Aug. 22, 2019

(54) ADAPTIVE CACHING USING NAVIGATIONAL GRAPHS

(71) Applicant: CA, Inc., New York, NY (US)

(72) Inventors: Arijit Dey, Hyderabad (IN); Subhasis Khatua, Hyderabad (IN); Surya Kiran Satyavarapu, Hyderabad (IN)

(21) Appl. No.: 15/902,299

(22) Filed: Feb. 22, 2018

(51) Int. Cl. G06F 12/0862; G06F 12/12

(52) U.S. Cl. CPC G06F 12/0862; G06F 2212/602; G06F 2212/1021; G06F 12/12

(57) ABSTRACT

A cache manager generates a navigational graph which includes nodes representing possible actions for an application and edges which indicate the ability for users to navigate among the actions. When selecting data to cache, the cache manager determines which actions in the navigational graph are currently being accessed by users and identifies connected nodes to which the users may subsequently navigate. The cache manager determines an index for each of the connected nodes and caches data for nodes which have the highest index. The cache manager can determine the index based on a variety of parameters including an aggregate probability distribution that the node will be reached by a user, a business criticality value for the node, a node response time for when the node data is not cached, a size of data associated with the node, and an average time that data for the node will be cached.

### BACKGROUND

The disclosure generally relates to the field of data processing, and more particularly to adaptive caching of application data.

A cache may be a processor cache, memory, or other quick access data storage device that an application can use for temporarily storing data. Applications cache data to shorten data access times and reduce latency thereby improving application performance. Caches are typically small and unable to store all data for a given application. Therefore, the application selectively determines which data to store. Some heuristics for selecting data to cache include least recently used or most frequently used data.

### BRIEF DESCRIPTION OF THE DRAWINGS

Aspects of the disclosure may be better understood by referencing the accompanying drawings.

FIG. 1 depicts an example cache management system for an application executing on a server.

FIG. 2 depicts an example navigational graph for an application.

FIG. 3 depicts a flowchart with example operations for managing a cache for an application.

FIG. 4 depicts a flowchart with example operations for caching data based on indexes.

FIG. 5 depicts an example computer system with an adaptive cache manager.

### DESCRIPTION

The description that follows includes example systems, methods, techniques, and program flows that embody aspects of the disclosure. However, it is understood that this disclosure may be practiced without these specific details. For instance, this disclosure refers to adaptively caching data for an application on a server in illustrative examples. Aspects of this disclosure can be also applied to adaptively caching data for database systems, distributed storage systems, etc. In other instances, well-known instruction instances, protocols, structures and techniques have not been shown in detail in order not to obfuscate the description.

Overview

Many caching strategies adhere to a static algorithm such as simply caching the least recently used data and fail to adapt to changing usage patterns or conditions for an application. As a result, many caching strategies fail to cache data that would be most beneficial for an application or provide the most improvement to an application's response time. To provide a more adaptive caching strategy, a cache manager generates a navigational graph which includes nodes representing possible actions for an application and edges which indicate the ability for users to navigate among the actions. The cache manager may also generate graphs for individual user sessions and enrich the navigational graph of the application with data indicating usage patterns of the application. When selecting data to cache, the cache manager determines which actions in the navigational graph are currently being accessed by users and identifies connected nodes to which the users may subsequently navigate. The cache manager determines an index for each of the connected nodes and caches data for nodes which have the highest index. The cache manager can determine the index based on a variety of parameters including an aggregate probability distribution that the node will be reached by a user, a business criticality value for the node, a node response time for when the node's data is not cached, a size of cacheable data associated with the node, and an average time that data for the node will be cached.

Terminology

The description below uses the term “navigational graph” to refer to a data structure that depicts connections or relationships between actions of an application. A navigational graph consists of nodes (vertices, points) and edges (arcs, lines) that connect them. A node represents an action of an application which can include displaying a web page, a data request, an application programming interface (API) request, etc. An edge between two nodes represents an ability for a user to navigate between the nodes or otherwise trigger an action of one node from another node. For example, if a first node is a web page, the second node may also be a web page which is linked to from the web page of the first node. The edges may be directional indicating that a user may only navigate in the indicated direction. Nodes and edges may be labeled or enriched with data. For example, a node may include an identifier for an action, an identifier for data associated with the action, a number of times an action has been executed, a business criticality value, a size of data for the node's action, an average time a user spends at the node, an average response time of the node when data is not cached, an average response time of the node which data is cached, etc. An edge may indicate a number of times users have navigated between the nodes connected by the edge. The navigational graph may be represented in a variety of data structures. In some implementations, a node may be indicated with a single value such as (A) or (B), and an edge may be indicated as an ordered or unordered pair such as (A, B) or (B, A). In implementations where nodes and edges are enriched with data, nodes and edges may be indicated with data structures that allow for the additional information, such as JavaScript Object Notation (“JSON”) objects, extensible markup language (“XML”) files, etc. Navigational graphs may also be referred to in related literature as an application map, relationship diagram/chart, etc.

Example Illustrations

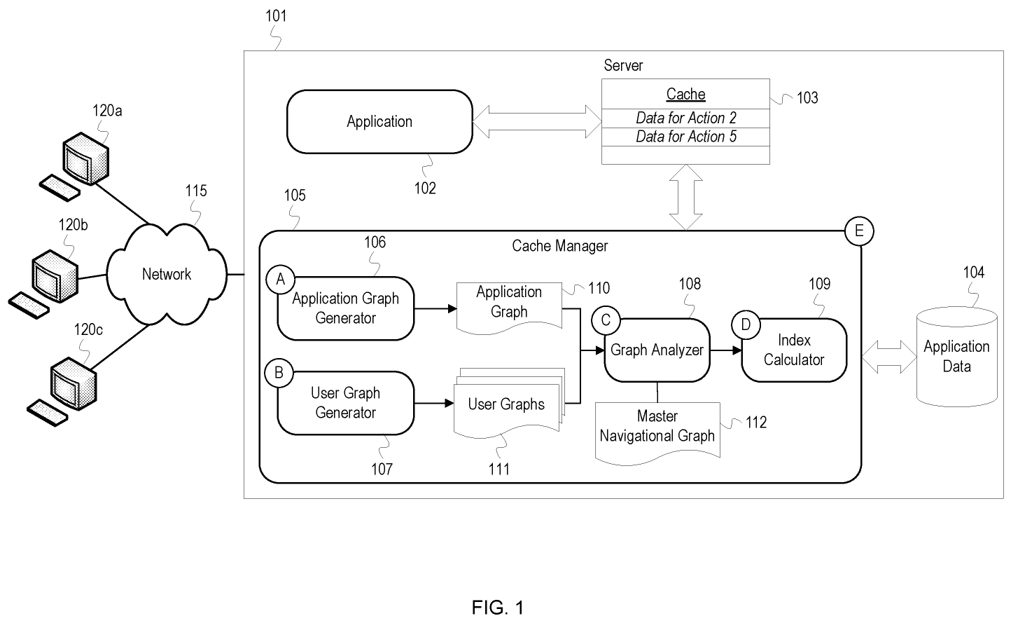

FIG. 1 depicts an example cache management system for an application executing on a server. FIG. 1 depicts a server 101, a network 115, and clients 120 (client 120a, 120b, and 120c). Executing on the server 101 is an application 102 and a cache manager 105. The server 101 also includes a cache 103. The cache manager 105 includes an application graph generator 106, a user graph generator 107, a graph analyzer 108, and an index calculator 109.

The cache 103 may be a disk cache, a processor cache, a memory cache, etc. The application data 104, although depicted within the server 101, may be an external database or storage device that is communicatively coupled to the server 101. The clients 120 are computers or mobile devices and are connected to the server 101 through the network 115. The clients 120 may be operated by users who direct the clients 120 to interact with the application 102. The application 102 may be a web application, virtual machine, or other network accessible software which provides data to the clients 120.

At stage A, the application graph generator 106 analyzes the application 102 to generate an application graph 110. The application graph 110 is a navigational graph with nodes representing possible pages, requests, or states of the application 102 (“actions”) and edges representing transitions/navigability between the actions. For example, if the application 102 is a website, a first node in the application graph 110 can represent an index or home page of the website, and a second node can represent another page in the website to which one of the clients 120 can navigate. An edge between the nodes indicates that a user can navigate from a first node to a second node or that an action of the second node can be executed from the first node. For example, an action of the second node may a be a request for data that is executed from a web page associated with the first node. To generate the application graph 110, the application graph generator 106 can use known techniques for analyzing the application 102 and extracting navigational structures of the application 102. For example, if the application 102 consists of static pages, the application graph generator 106 can build the application graph 110 using a classical graph traversal algorithm, such as a depth-first search algorithm. The nodes of the application graph 110 may include identifiers or attribute information related to the states of the application 102. For example, if each node is associated with an HTML page, nodes may be labeled with file names of the HTML pages, such as “index.html.” As an additional example, a node may represent a page which displays data from a database, so the node may include an identifier for the database and query language which identifies data retrieved by the application 102 for the node. Since the various states of the application 102 are relatively static, the application graph generator 106 may generate the application graph 110 a single time or may refresh the application graph 110 periodically or after updates to the application 102. After generating the application graph 110, the application graph generator 106 provides the application graph 110 to the graph analyzer 108.

At stage B, the user graph generator 107 generates user graphs 111 for users of the application 102. The user graphs 111 are navigational graphs which indicate a user's traversal through the actions of the application 102. The user graph generator 107 monitors user's traffic and records their progression through the application 102 in the user graphs 111. Users of the clients 120 may login with credentials or otherwise initiate a session with the application 102. The user graph generator 107 may create a user graph for each unique user session. In some implementations, the application 102 can track users and create user graphs based on the clients' 120 Internet Protocol (IP) or media access control (MAC) addresses. The user graph generator 107 adds a node for each action of the application 102 to which a user navigates and a corresponding edge indicating the transition or navigability between actions. The edges of the graph may be directional indicating a user's navigation to and from nodes of the graph. The user graph generator 107 can enrich nodes and edges of the user graphs 111 with information indicating how long a user spent at each node, a number of times a user navigated to and from a particular node, etc. The user graph generator 107 can label each of the user graphs 111 with identification information for each user such as a username or other credential and store the user graph for each unique user of the application 102. For example, the user graphs 111 may be stored in a database and retrieved using a user's credential, IP address, etc.

Each time a user initiates a session with the application 102, the user graph generator 107 may retrieve the user graph corresponding to the particular user and continue adding nodes and updating the data in the user graph. For example, the user graph generator 107 may increment a counter for a node each time a user executes the corresponding action of the application 102. As a result, a user graph can represent cumulative navigational patterns for a user over time. Alternatively, in some implementations, the user graph generator 107 does not store user graphs and generates a new user graph for each user session. As the user graphs are being generated, the user graph generator 107 may continuously provide updates of the user graphs 111 to the graph analyzer 108 as they are detected. In some implementations, the user graph generator 107 may provide a user graph after a user session has terminated.

At stage C, the graph analyzer 108 merges data from the user graphs 111 with the application graph 110 to create the master navigational graph 112. The master navigational graph 112 reflects cumulative navigational patterns of all users of the application 102. The graph analyzer 108 creates the master navigational graph 112 by enriching the application graph 110 with navigational data extracted from the user graphs 111. The nodes in the resulting master navigational graph 112 indicate a total number of times each node has been reached or executed, and the edges in the master navigational graph 112 indicate the total number of transitions between nodes by all users. The data in the master navigational graph 112 may be added in a manner to allow for filtering of the cumulative navigational data based on users currently accessing the application 102. For example, a node can include a list that indicates which users have accessed the node and a number of times each user has executed the node's action. The number of executions for the node indicated in the master navigational graph 112 may be a summation of individual user executions in the list after the list has been filtered to include only the users currently accessing the application 102. In other implementations, the graph analyzer 108 may generate the master navigational graph 112 to only reflect current users of the application 102. For example, the graph analyzer 108 may generate the master navigational graph 112 on the fly using the user graphs 111 for user currently accessing the application 102. The graph analyzer 108 can add or remove user data to the master navigational graph 112 as new user sessions are initiated or terminated with the application 102. If only the client 120a is accessing the application 102, the master navigational graph 112 will only reflect the data in the client 120a's user graph. If the client 120b imitates a session with the application 102, the graph analyzer 108 updates the master navigational graph 112 to also include data from the client 120b's user graph.

At stage D, the index calculator 109 determines data to be loaded into the cache 103. Each node of the master navigational graph 112 represents an action of the application 102 that utilizes data from the application data 104. The index calculator 109 uses the master navigational graph 112, the user graphs 111, and other parameters to determine which data from the application data 104 would be most beneficial to store in the cache 103 given the current usage of the application 102. The index calculator 109 retrieves current usage data for the application 102 which indicates which actions in the master navigational graph 112 the clients 120 are currently accessing. For example, the client 120a and client 120b may be at an action 1, and the client 120c may be at an action 4. The index calculator 109 identifies nodes in the master navigational graph 112 corresponding to the currently accessed actions of the application 102 and then determines which actions may be subsequently accessed based on which nodes are connected to the identified nodes. Subsequently or imminently accessed actions can be defined as actions/nodes that are a threshold number of edges away from a currently accessed action/node in the master navigational graph 112. For example, if a user is currently at a first node, the index calculator 109 determines that any nodes connected by two or fewer edges to the first node may be subsequently accessed by the first user. Furthermore, the index calculator 109 can also retrieve user graphs from the user graphs 111 for users currently accessing the application 102 so that individual user patterns can be considered when calculating an index. The index calculator 109 determines a score or index for each action which might be subsequently accessed and caches the data for the action with the highest index. The index can be defined as a function of one or more of the following parameters:

Index=f{N_{apd}, N_{bc}, Nₙᵣₜ, N_{cds}, N_{acd}} (1)

where,
N_{apd}=Aggregate Probability Distribution for the Node
N_{bc}=Business Criticality
Nₙᵣₜ=Node Response Time
N_{cds}=Cacheable Data Size
N_{acd}=Average Cache Duration

Aggregate probability distribution for an action indicates the probability of a action being executed or accessed by one or more users of the application 102. The aggregate probability distribution is dependent on the number of total number of users currently accessing the application 102 and the portion of those users at a connected node. The index calculator 109 can calculate the aggregate probability distribution for a node based on a number of concurrent users at a parent node and data in the master navigational graph 112 indicating how frequently users navigate to the node from the parent node. The index calculator 109 may also calculate the probability for each user at a parent node individually based on a user's user graph and then aggregate all of the individual probabilities. The index calculator 109 may calculate the probability with user graphs for just users currently accessing the system so that the calculated index is responsive to current, unique user patterns. Furthermore, in instances where data for the potentially accessed node is already cached, the index calculator 109 may consider a probability that the cached data is stale and, therefore, needs to be refreshed. The probability that data needs to be refreshed or is stale may be based on a frequency with which that application 102 modifies the data in the cache 103 or the application data 104 and the amount of time the data has been in the cache 103. For a given node and for a single user, the probability that the data at the node should be cached is the product of the probability of data being stale and probability of the node being requested:

P_{C}(data to be cached)=P_{R}(request probability)*P_{S}(stale data) (2)

The probabilities P_{R} and P_{S} may each follow a Poisson distribution. When all users are taken into account, the overall probability that the data should be cached can be determined by aggregating the individual probabilities:

N_{APD}(aggregate probability)=Σ(P_{C}) (3)

Business criticality refers to the business value or importance of a node's data that could be cached. For example, financial data or data for an important project may be considered more important or time-sensitive for a business than data such as employee contact information. As an additional example, if data is often accessed by a user who is indicated as an executive officer of the business, the data may be assigned a higher business criticality value. Each node in the master navigational graph 112 may be assigned a business criticality value, e.g. in a range from 0-100, indicating the importance of the action or data associated with that action. Instead of a fixed value, the business criticality value for a node may be determined based on a function which takes parameters of the application 102, the user, and the node as arguments and returns a numeric value. The returned numeric value may be within a defined range of values or otherwise normalized to have a value that is relative to business criticality values of other nodes. The parameters can include a role of a user(s) which might access the node, category/type of data (e.g., financial, administrative, etc.) associated with the node, current time/date and relation of the time/date to a business calendar, location of a user(s) which might access the node, etc. Regarding user roles, certain roles within an organization (e.g. executive officers, chairman, vice presidents) may be given a higher priority for data access. If a user with a high priority role may imminently access a node, the node's business criticality value will be increased versus when a user with low/no priority may access the node. The business criticality value for a node can also be increased for based on a current time and date. If the data for the node is frequently accessed in the afternoon, the business criticality value will be increased during the afternoon and lower in the morning or evening. As an additional example, business criticality values for financial data may be increased toward the end of fiscal quarters when that data is important and most frequently accessed. Regarding a user's location, if a user's location indicates they are outside of the office, the index calculator 109 can determine that the user is on a business trip and increase the business criticality values of nodes which the user may access. Through the addition of other parameters, the function for a business criticality value can be tailored to a type of business using the application 102. For example, a sales company may prioritize financial data, while a doctor's office may prioritize medical record access.

Node response time refers to the usual response time for a node's action when data for the node is not cached. In other words, the node response time is the time taken for the application 102 to provide data to a client when the requested data is not in the cache 103 and the application 102 must retrieve the data from the application data 104. The application graph generator 106 may determine the response time for each node's action when generating the application graph 110, or the index calculator 109 may infer or estimate the node response time based on a size of data associated with an action. Alternatively, the index calculator 109 may retrieve performance data from an application performance monitoring system or an event log indicating actions and performance metrics of the application 102.

Cacheable data size refers to the amount of data that would be cached for a given node. Caching large, frequently accessed data is beneficial since the time and resource savings can be greater when caching larger data. The application graph generator 106 may monitor the cache 103 during operation of the application 102 and add the size of the cached data for each action to corresponding nodes in the application graph 110.

Cache duration refers to the effective duration for which data should be cached for a node. Based on analysis of usage patterns, the application graph generator 106 can determine the average duration a user spends on each node's action and record the information in the application graph 110. In general, the longer data is cached the more benefit is derived from spending resources the cache the data.

During stage D, the index calculator 109 uses one or more of the above parameters to determine an index for each node which may be subsequently accessed by the current users of the application 102. For example, the index calculator 109 may calculate a sum of the parameters to determine a total index for a node as follows:

Index=w₁N_{apd}+w₂N_{bc}+w₃Nₙᵣₜ+w₄N_{cds}+w₅N_{acd} (4)

As shown above, the index calculator 109 may assign weights to each of the parameters to emphasize or diminish the effect of a given parameter on the index. In general, the parameters and their weights in combination are used to cumulatively determine an index for a node. For example, if a cacheable data size is for a node large and the aggregate probability to access the node is low, the cacheable data size parameter may be given a lesser weight. The index calculator 109 may also normalize the values of the parameters so that they are all within a range, such as 0-10. For example, a cacheable data size may be normalized to a scale of 0-10 based on the size of cacheable data in relation to other cacheable data sizes, e.g. a 10 may represent the largest relative size and a 0 the smallest relative size.

After calculating an index for each potentially accessed node, the index calculator 109 instructs the cache manager 105 to cache data for nodes with the highest index values in the cache 103. In FIG. 1, the cache manager 105 has stored in the cache 103 “Data for Action 2” and “Data for Action 5.” The amount of data cached is based on the amount of available storage space in the cache 103. In some implementations, a portion of the cache 103 may be reserved for more traditional caching techniques such as least recently used, and another portion reserved for the adaptive caching strategy described in FIG. 1.

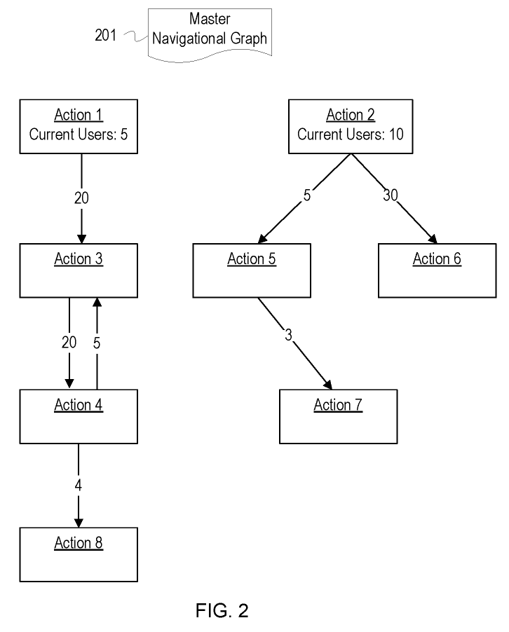

FIG. 2 depicts an example navigational graph for an application. FIG. 2 depicts a master navigational graph 201. FIG. 2 is a simplistic example to allow for ease of illustration and explanation. In reality, the master navigational graph 201 will comprise hundreds or thousands of interconnected nodes representing possible actions of an application.

The nodes of the graph 201 are labeled as “Action 1,” “Action 2,” etc. The edges connecting the nodes indicate a number of times which a user has transitioned from the parent node to the child node. For example, users have navigated from Action 1 to Action 3 twenty times. Also, nodes for “Action 1” and “Action 1” indicate a number of current users for those nodes. A cache manager (not depicted) uses the master navigational graph 201 to determine which data for the application would be most beneficial to cache. The cache manager calculates an index for each node to which the current users may potentially navigate. In FIG. 2, those nodes include the nodes for Action 3, Action 5, and Action 6. In some implementations, the cache manager may also calculate index values for second level children, which includes Action 4 and Action 7. The cache manager may not calculate an index for Action 8 since that node is three levels away from any current users.

After calculating indexes for Action 3, Action 5, and Action 6, the cache manager compares the indexes and caches data for one or more of the largest index values. Based on the example values in FIG. 2, the cache manager may determine that Action 6 has the largest index. Action 6 may have the largest index since Action 2 has the most current users and the usage pattern data indicates that users have navigated from Action 2 to Action 6 thirty times. As a result, Action 6 may have the highest probability of being subsequently accessed or executed. Since Action 6 has the largest index, the cache manager caches data for the Action 6. Action 3 may have the second largest index. Even though Action 2 has more current users, the usage pattern data indicates that users rarely navigate from Action 2 to Action 5; thus, it is more probable that users will execute Action 3 than Action 5. As a result, the cache manager may also cache data for the Action 3. Although the usage pattern data indicates that execution of Action 3 is more probable, other parameters for Action 5 not depicted may indicate that caching data for Action 5 is more beneficial. For example, Action 5 may have a high business criticality value leading to a higher index for Action 5.

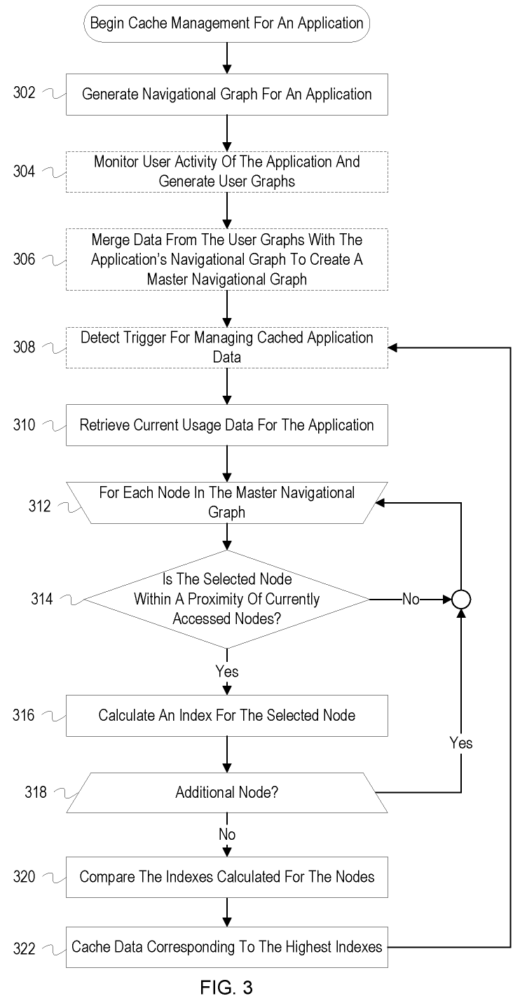

The cache manager continues caching data for actions with the largest index values so long as there is sufficient space in the cache. Once the cache is full, the cache manager may wait until there is again available space for caching data, until current usage data has changed, until a time period has expired, etc. Once a trigger for managing the cache is detected, the cache manager reperforms calculations for selecting data to cache as described in more detail in FIG. 3.

FIG. 3 depicts a flowchart with example operations for managing a cache for an application. FIG. 3 refers to a cache manager as performing the operations for naming consistency with FIG. 1 even though identification and naming of program code can vary by developer, language, platform, etc.

A cache manager generates a navigational graph for an application (302). The navigational graph includes nodes that indicate possible actions of the application and edges that indicate the ability to transition or navigate between the actions. To determine the possible actions of the application, the cache manager may use an algorithm to crawl the application, analyze program code of the application, analyze an event log for the application, monitor operation of the application, detect API requests, etc. The cache manager also identifies data for each of the nodes which is accessed by the application upon execution of the node's action. The cache manager may add identifiers for the data to the corresponding nodes or otherwise indicate the associated cacheable data.

The cache manager monitors user activity of the application and generates user graphs (304). The cache manager can detect when a user initiates a session with the application and begin tracking the user's movements through the application. The cache manager generates a user graph for the user which indicates which actions the user executed and how the user navigated through the application. The cache manager may store the user's graph and may update or modify the graph based on subsequent user sessions.

The cache manager merges data from the user graphs with the application's navigation graph to create a master navigational graph (306). The master navigational graph includes all nodes and edges from the application's navigational graph and includes aggregated data from the generated user graphs. As a result, the master navigational graph reflects overall usage patterns of the application.

The cache manager detects a trigger for managing cached application data (308). The cache manager performs the operations described in blocks 310-322 upon detecting a trigger that the application's cache needs to be managed. The cache manager may perform the operations periodically or may be triggered based on a variety of conditions. For example, the cache manager may be triggered upon detecting that data has been flushed from the cache and there is available space for caching data, upon detecting that additional users have initiated a session with the application, upon determining that the application has started/restarted, upon determining that cached data is stale, etc.

Blocks 304, 306, and 308 are depicted with dashed lines since these blocks reflect background operations that may be continuously running during operation of the cache manager. For example, the cache manager may be continuously monitoring user activity and generating/modifying user graphs, as well as merging those user graphs with the master navigational graph data. Similarly, the cache manager may be continually monitoring for triggers for the caching operations described below. Once a trigger is detected, the cache manager may toll monitoring for triggers while the operations below are performed and resume monitoring after data has been cached.

Once a trigger is detected, the cache manager retrieves current usage data for the application (310). The cache manager determines how many users are currently accessing the application and determines which actions are currently being executed or accessed. The cache manager may update nodes in the master navigational graph to indicate which actions are currently being executed or accessed by the users.

The cache manager begins traversing the master navigational graph to calculate indexes for actions of the application which may be imminently accessed (312). The cache manager may traverse through the navigational graph using known traversal algorithms. The node for which the cache manager is currently performing operations is hereinafter referred to as “the selected node.”

The cache manager determines whether the selected node is within a proximity of currently accessed nodes (314). The cache manager may be configured with a threshold for determining whether nodes are within proximity of a currently accessed node. For example, the cache manager may only consider a node to be within proximity of a currently accessed node if the nodes are connected by three or fewer edges, i.e. are within three or less levels or degrees of each other. The cache manager identifies all nodes connected by the threshold level of edges to the selected node and determines if any of those nodes are currently being accessed by a user. If the proximity threshold is two levels, the cache manager analyzes adjacent nodes and twice removed nodes for current users. If the edges in the navigational graph are directed, the cache manager may filter out nodes which do not have edges directed toward the selected node, since this indicates that a user could not navigate to the selected node from those nodes. If any of the connected nodes in proximity of the selected node indicate current users, the cache manager determines that the selected node is within proximity of a currently accessed node and has potential to be subsequently executed by a user. If the cache manager determines that the selected node is not within proximity of currently accessed nodes, the cache manager selects the next node from the master navigational graph (312).

If the cache manager determines that the selected node is within proximity of a currently accessed node, the cache manager calculates an index for the selected node (316). The cache manager calculates an index for the selected node based on parameters such as an aggregate probability distribution that an action for the selected node will be executed or requested, a business criticality value for the node, an expected cache duration, a size of cacheable data, a number of current users of the selected node, whether the selected node already has cached data, etc. The cache manager may be configured to use one or more of these parameters. For example, the index may be based solely on the aggregate probability distribution or a probability that a user will navigate to the selected node. After calculating the index, the cache manager may add an identifier for the node and the calculated index value to a table or list in memory.

The cache manager determines whether there is an additional node in the master navigational graph (318). If the cache manager determines that there is another node, the cache manager selects the next node from the master navigational graph (318).

If the cache manager determines that there is not another node, the cache manager compares the calculated indexes for the nodes (320). The cache manager may analyze or sort the list containing the proximate nodes and their indexes determined at block 316. The cache manager uses the list to identify nodes with the highest indexes.

The cache manager caches data corresponding to the nodes with the highest indexes (322). The cache manager retrieves data for the actions indicated in the nodes from storage and stores the data in a cache of a server executing the application. The cache manager may continue caching the data for nodes with the highest indexes until the cache is full or until space in the cache reserved for adaptive caching is full.

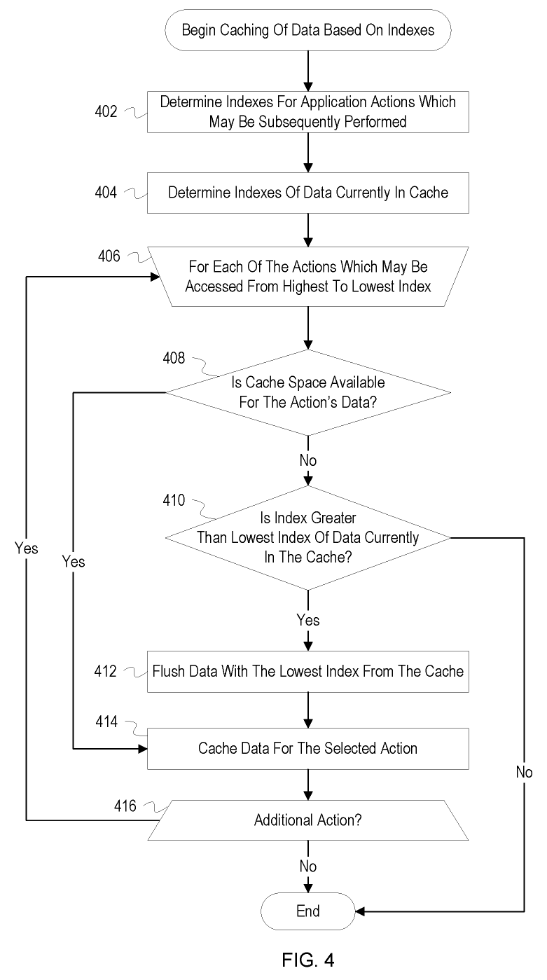

FIG. 4 depicts a flowchart with example operations for caching data based on indexes. FIG. 4 refers to a cache manager as performing the operations for naming consistency with FIG. 1 even though identification and naming of program code can vary by developer, language, platform, etc. FIG. 4 elaborates on operations which may be performed during block 322 of FIG. 3.

A cache manager determines indexes for application actions which may be subsequently performed (402). The indexes may be determined in a manner similar to the operations described in FIG. 3.

The cache manager determines indexes of data currently in a cache (404). When data is cached, the cache manager may also store an index for the data in the cache or in a table in memory used to track currently cached data. As a result, each piece or set of data in the cache may be associated with an index which was calculated at the time the data was cached. To determine indexes of the data, the cache manager retrieves the previously calculated indexes and may recalculate or update the indexes in light of current usage conditions of the application. In some implementations, the cache manager may continually monitor and update index values of cached data and flush data from the cache if its index falls below a threshold.

The cache manager begins determining whether data should be cached for each of the actions (406). The cache manager iterates through the application actions in order from highest index to lowest index. The action for which the cache manager is currently performing operations is hereinafter referred to as “the selected action.”

The cache manager determines whether cache space is available for the selected action's data (408). The cache manager monitors available space in the cache and has a record of available storage space in the cache. The cache manager determines of size of the selected action's data and then determines whether there is sufficient free space to store the data.

If there is not sufficient space for the selected action's data, the cache manager determines whether the index of the selected action is greater than the lowest index of data currently in the cache (410). The cache manager compares the index of the selected data to the lowest index determined for data in the cache. If the index of the selected action is greater than the lowest index, the cache manager determines that it would be more beneficial or useful to cache the selected action's data. If the index of the selected action is not greater than the lowest index, the process ends. Since the cache manager is iterating over the selected actions from highest to lowest index, the cache manager can cease iterating through actions because none of the remaining actions will have a higher index than data currently in the cache.

If the index of the selected action is greater than the lowest index of currently cached data, the cache manager flushes data with the lowest index from the cache (412). The cache manager creates space for the selected action's data by flushing data with the lowest index from the cache. Based on the size of the selected action's data, the cache manager may flush more than one data entry from the cache to create the needed space. The cache manager may continue flushing data until there is sufficient space or until an index of data to be flushed is greater than the index of the selected action. When flushing data, the cache manager may write the flushed data back to storage of the application.

If there is cache space available for the selected action's data or after flushing data with the lowest index from the cache, the cache manager caches data for the selected action (414). The cache manager retrieves the selected action's data from storage and stores the data in the cache. The cache manager can identify the data for the action based on data identifiers, queries, or API calls indicated in a node for the action in a navigational graph. For example, the node may include file names for data associated with an action. If the node includes query language, the cache manager may retrieve the selected action's data by executing the query on a database for the application. If the node includes an API call, the cache manager may invoke the indicated API function and store the returned data in the cache.

The cache manager determines whether there is an additional action (416). If there is an additional action, the cache manager selects the action with the next highest index (406). If there is not an additional action, the process ends.

Variations

FIG. 1 is annotated with a series of letters A-D. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

The examples often refer to a cache manager. The cache manager is a construct used to refer to implementation of functionality for managing the storage of data in a cache. This construct is utilized since numerous implementations are possible. A cache manager may be a processor, an agent, a buffer, a particular component or components of a machine (e.g., a particular circuit card enclosed in a housing with other circuit cards/boards), machine-executable program or programs, firmware, a circuit card with circuitry configured and programmed with firmware for managing a cache, etc. The term is used to efficiently explain content of the disclosure. The cache manager can also be referred to as a data analyzer, a buffer director, etc. Although the examples refer to operations being performed by a cache manager, different entities can perform different operations. For instance, a dedicated co-processor or application specific integrated circuit can generate navigational graphs and collect usage data for an application.

The description above refers to the cache manager operating on a single server. In some implementations, the cache manager may execute across a plurality of servers or nodes of distributed system. Each of the cache management services across the servers may operate independently and cache data based on the traffic of users experienced at each server. In other implementations, a single cache manager may server as a lead cache manager and communicate which data is to be cached to each of the other cache managers. In still other implementations, differing levels of communication and coordination among the cache managers are possible.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

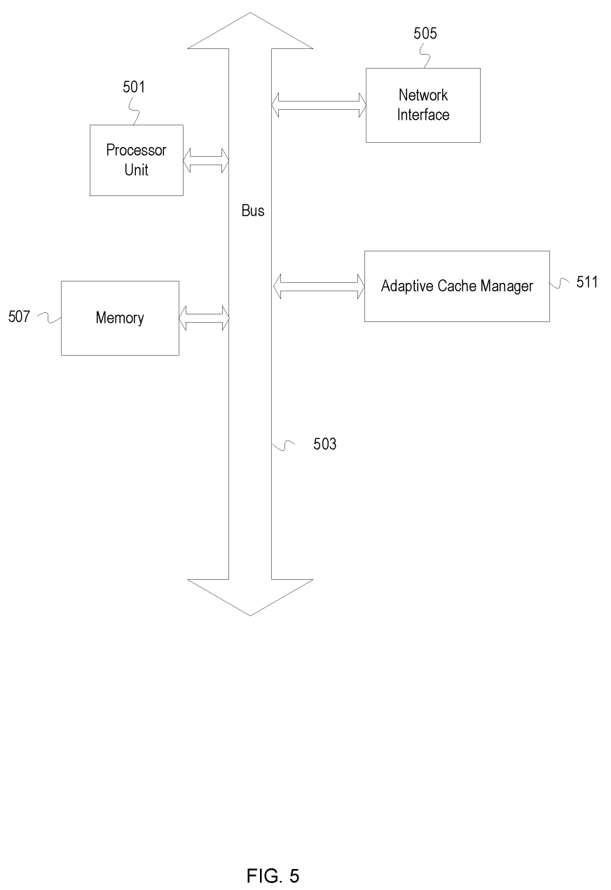

FIG. 5 depicts an example computer system with an adaptive cache manager. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes an adaptive cache manager 511. The adaptive cache manager 511 caches data based on usage patterns of an executing application. The cache in FIG. 5 may be the memory 507. Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for adaptively managing a cache based on current usage patterns of an application as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

This description uses shorthand terms related to cloud technology for efficiency and ease of explanation. When referring to “a cloud,” this description is referring to the resources of a cloud service provider. For instance, a cloud can encompass the servers, virtual machines, and storage devices of a cloud service provider. The term “cloud destination” and “cloud source” refer to an entity that has a network address that can be used as an endpoint for a network connection. The entity may be a physical device (e.g., a server) or may be a virtual entity (e.g., virtual server or virtual storage device). In more general terms, a cloud service provider resource accessible to customers is a resource owned/manage by the cloud service provider entity that is accessible via network connections. Often, the access is in accordance with an application programming interface or software development kit provided by the cloud service provider.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
generating a navigational graph for an application, wherein the navigational graph represents a set of actions performed by the application;
determining that a first action of the set of actions is being accessed;
identifying a subset of the set of actions which may be performed after the first action based, at least in part, on the navigational graph;
determining an index for each action in the subset of actions; and
caching data associated with a second action of the subset of actions in a cache of a device executing the application based, at least in part, on the determined index of the second action.

2. The method of claim 1 further comprising:
based on determining that the cache is full,
determining an index for each data entry in the cache;
based on determining that the index for a third action in the subset of actions is higher than at least one of the indexes for the data entries, removing a data entry with a lowest index from the cache; and
caching data associated with the third action in the cache.

3. The method of claim 1, wherein caching data associated with the second action of the subset of actions in the cache of the device executing the application based, at least in part, on the determined index of the second action comprises:
comparing the indexes of the subset of actions; and
determining that the second action has a highest index of the indexes.

4. The method of claim 1, wherein identifying the subset of actions which may be performed after the first action based, at least in part, on the navigational graph comprises:
identifying a first node in the navigational graph representing the first action;
identifying a set of nodes adjacent to the first node in the navigational graph; and
determining actions represented by the set of nodes.

5. The method of claim 1 further comprising:
monitoring navigational patterns of users in relation to the set of actions;
indicating a number of executions for each of the set of actions has been performed in nodes of the navigational graph; and
indicating a number of transitions between each of the set of actions in edges of the navigational graph.

6. The method of claim 5, wherein determining an index for each action in the subset of actions comprises:
determining a number of users currently accessing the first action; and
for each action in the subset of actions, calculating a probability that the action will be performed after the first action based, at least in part, on the number of users currently accessing the first action, the number of executions indicated in a node for the action, and the number of transitions indicated in an edge between the action and the first action.

7. The method of claim 1, wherein determining an index for each action in the subset of actions comprises:
for each action in the subset of actions,
determining a size of cacheable data for the action;
determining an average duration that data for the action is cached; and
adjusting the index for the action based, at least in part, on the size of the cacheable data and the average duration.

8. The method of claim 1, wherein determining an index for each action in the subset of actions comprises:
for each action in the subset of actions,
determining an average response time for the action when data for the action is not cached; and
adjusting the index for the action based, at least in part, on the average response time for the action when data for the action is not cached.

9. The method of claim 1, wherein determining an index for each action in the subset of actions comprises:
for each action in the subset of actions,
determining a business criticality value for the action; and
adjusting the index for the action based, at least in part, on the business criticality value.

10. One or more non-transitory machine-readable media comprising program code, the program code to:
generate a navigational graph for an application, wherein the navigational graph represents a set of actions performed by the application;
determine that a first action of the set of actions is being accessed;
identify a subset of the set of actions which may be performed after the first action based, at least in part, on the navigational graph;
determine an index for each action in the subset of actions; and
cache data associated with a second action of the subset of actions in a cache of a device executing the application based, at least in part, on the determined index of the second action.

11. The machine-readable media of claim 10 further comprising program code to:
based on a determination that the cache is full,
determine an index for each data entry in the cache;
based on a determination that the index for a third action in the subset of actions is higher than at least one of the indexes for the data entries, remove a data entry with a lowest index from the cache; and
cache data associated with the third action in the cache.

12. An apparatus comprising:
a processor; and
a machine-readable medium having program code executable by the processor to cause the apparatus to,
generate a navigational graph for an application, wherein the navigational graph represents a set of actions performed by the application;
determine that a first action of the set of actions is being accessed;
identify a subset of the set of actions which may be performed after the first action based, at least in part, on the navigational graph;
determine an index for each action in the subset of actions; and
cache data associated with a second action of the subset of actions in a cache of a device executing the application based, at least in part, on the determined index of the second action.

13. The apparatus of claim 12 further comprising program code executable by the processor to cause the apparatus to:
based on a determination that the cache is full,
determine an index for each data entry in the cache;
based on a determination that the index for a third action in the subset of actions is higher than at least one of the indexes for the data entries, remove a data entry with a lowest index from the cache; and
cache data associated with the third action in the cache.

14. The apparatus of claim 12, wherein the program code executable by the processor to cause the apparatus to cache data associated with the second action of the subset of actions in the cache of the device executing the application based, at least in part, on the determined index of the second action comprises program code executable by the processor to cause the apparatus to:
compare the indexes of the subset of actions; and
determine that the second action has a highest index of the indexes.

15. The apparatus of claim 12, wherein the program code executable by the processor to cause the apparatus to identify the subset of actions which may be performed after the first action based, at least in part, on the navigational graph comprises program code executable by the processor to cause the apparatus to:
identify a first node in the navigational graph representing the first action;
identify a set of nodes adjacent to the first node in the navigational graph; and
determine actions represented by the set of nodes.

16. The apparatus of claim 12 further comprising program code executable by the processor to cause the apparatus to:
monitor navigational patterns of users in relation to the set of actions;
indicate a number of executions for each of the set of actions has been performed in nodes of the navigational graph; and
indicate a number of transitions between each of the set of actions in edges of the navigational graph.

17. The apparatus of claim 16, wherein the program code executable by the processor to cause the apparatus to determine an index for each action in the subset of actions comprises program code executable by the processor to cause the apparatus to:
determine a number of users currently accessing the first action; and
for each action in the subset of actions, calculate a probability that the action will
be performed after the first action based, at least in part, on the number of users currently accessing the first action, the number of executions indicated in a node for the action, and the number of transitions indicated in an edge between the action and the first action.

18. The apparatus of claim 12, wherein the program code executable by the processor to cause the apparatus to determine an index for each action in the subset of actions comprises program code executable by the processor to cause the apparatus to:
for each action in the subset of actions,
determine a size of cacheable data for the action;
determine an average duration that data for the action is cached; and
adjust the index for the action based, at least in part, on the size of the cacheable data and the average duration.

19. The apparatus of claim 12, wherein the program code executable by the processor to cause the apparatus to determine an index for each action in the subset of actions comprises program code executable by the processor to cause the apparatus to:
for each action in the subset of actions,
determine an average response time for the action when data for the action is not cached; and
adjust the index for the action based, at least in part, on the average response time for the action when data for the action is not cached.

20. The apparatus of claim 12, wherein the program code executable by the processor to cause the apparatus to determine an index for each action in the subset of actions comprises program code executable by the processor to cause the apparatus to:
for each action in the subset of actions,
determine a business criticality value for the action; and
adjust the index for the action based, at least in part, on the business criticality value.
